(19) United States
(12) Patent Application Publication
(10) Pub. No.: US 2010/0119273 A1
(43) Pub. Date: May 13, 2010

(54) IMAGE FORMING APPARATUS AND METHOD OF CORRECTING COLOR IMAGE MISALIGNMENT

(76) Inventors: Kunihiro KOMAI, Ibaraki city (JP); Tatsuya Miyadera, Ikeda city (JP); Yoshinori Shirasaki, Ikeda city (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/616,267

(22) Filed: Nov. 11, 2009

(30) Foreign Application Priority Data
Nov. 13, 2008 (JP) 2008-290904
Nov. 4, 2009 (JP) 2009-253209

(51) Int. Cl. G03G 15/00

(52) U.S. Cl. 399/395

(57) ABSTRACT

An image forming apparatus includes an endless belt, image forming units disposed along the endless belt, an image skew obtaining unit, a recording medium skew obtaining unit, and a skew correction unit. The image forming unit includes an image carrying member to form a toner image. A correction pattern formed of toner image is formed on the endless belt. The image skew obtaining unit obtains skew of toner image based on a detection result of the correction pattern. The recording medium skew obtaining unit obtains skew of the recording medium based on detection of an edge of the recording medium. The skew correction unit corrects an image forming position of the toner image on the image carrying member using correction data prepared from the obtained skew for the correction pattern and the obtained skew for the recording medium.

### CROSS-REFERENCE TO RELATED APPLICATIONS

This application claims priority to Japanese Patent Application Nos. 2008-290904, filed on Nov. 13, 2008, and 2009-253209, filed on Nov. 4, 2009 in the Japan Patent Office, which are hereby incorporated by reference herein in their entirety.

### BACKGROUND OF THE INVENTION

1. Field of the Invention

The present invention relates to a tandem-type image forming apparatus including a method of correcting color image misalignment, and more particularly, a tandem-type image forming apparatus and a method to correct color image misalignment by using skew of color image and skew of a recording medium.

2. Description of the Background Art

Color image forming apparatus employing electrophotography for forming images may include a photoconductor drum. When an image forming operation is conducted, the photoconductor drum is charged by a charging unit, a laser beam generated based on image data is directed onto the charged photoconductor drum to form a latent image on the photoconductor, the latent image is developed as a toner image by a development unit, and then the developed toner image is transferred to a recording sheet to form an image thereon.

Such color image forming operation may be conducted by disposing a plurality of image forming stations along an intermediate transfer belt (e.g., endless belt). Specifically, image forming stations for forming cyan (C), magenta (M), yellow (Y), and black (K) toner images may be disposed, in that order or another, along the intermediate transfer belt, wherein each of the image forming stations includes a photoconductor drum to form a toner image of that color thereon.

The toner images formed on each of the photoconductor drums may be transferred to a recording sheet either indirectly using an intermediate transfer method or directly in a direct transfer method. When the toner images are transferred indirectly, the toner images are first sequentially transferred to and superimposed on a surface of the intermediate transfer belt, and then subsequently the toner images on the intermediate transfer belt are transferred onto a recording sheet conveyed separately from but in conjunction with the intermediate transfer belt.

By contrast, when the toner images are transferred directly, the toner images formed on each of the photoconductor drums are sequentially transferred and superimposed on a surface of recording sheet transported by a media transport belt on which the recording medium is conveyed during the process of forming an image thereon, without the use of the intermediate transfer belt described above that is used in the indirect transfer method.

As such, in the tandem-type image forming apparatus, toner images formed on each of the photoconductor drums are transferred to and superimposed on either an intermediate transfer belt or a recording sheet transported by a media transport belt. Accordingly, if a transfer position of any color toner image deviates from its intended position, a defective image having color image misalignment is formed on the recording sheet.

The tandem-type image forming apparatus may include a system to correct such color image misalignment. Specifically, the image forming apparatus may include a photo-electronic sensor to detect such color image misalignment, whereby, for example, a given toner pattern (test pattern) for each color for correcting color image misalignment is formed on the intermediate transfer belt or the media transport belt, and then the correction pattern is detected by the photo-electronic sensor using the black (K) image as a reference image. Using the black image as reference image, image misalignment of other three color images can be detected. Specifically, skewed condition, registration deviation in a main scanning direction, registration deviation in a sub-scanning direction, uneven pitch condition in a sub-scanning direction, and magnification error in a main scanning direction for the other three color images are computed. The computed result is then used as feedback for the image forming process to eliminate such color image misalignment.

In such correction process, skew correction may be conducted with a mechanical method or electrical method. In the mechanical method, an adjustment unit may be provided in a writing unit that emits the laser beam to carry out the correction process by adjusting the position of a mirror that deflects the laser beam. Such a configuration requires an actuator such as a motor to move the mirror to conduct the correction process, which results in a cost increase and a size increase for the writing unit, which is undesirable.

On the other hand, in the electrical method, which uses an image processing technique, image data is stored in a line memory and the read-out timing for reading out the image data from the line memory is controlled so that the positions of the toner images to be formed on the photoconductor drums are shifted in a direction opposite to the skewed direction, thus correcting any skew between different color images. The electrical method may be implemented at reduced cost compared to the mechanical method. Such skew correction method for an image forming apparatus or image forming method is disclosed, for example, in JP-2008-46488-A.

Although the apparatus and method of JP-2008-46488-A can conduct such skew correction process, and prints an image on a recording sheet based on image data processed by the skew correction process, an image such as color image slanted from a correct direction may be formed on the recording sheet if the recording sheet itself, transported on a media transport belt or the like, is skewed from its proper orientation or direction.

### SUMMARY

In one aspect of the present invention, an image forming apparatus is devised that includes an endless belt, a plurality of image forming units, an image skew obtaining unit, a recording medium skew obtaining unit, and a skew correction unit. The plurality of image forming units is disposed along the endless belt. Each of the image forming units includes an image carrying member to form a toner image of each color thereon based on image data. The toner image of each color is sequentially transferable onto a recording medium as a superimposed color image. A color image misalignment correction pattern formed of toner image of each color is formed on the endless belt. The image skew obtaining unit obtains skew of toner image based on a detection result of the color image misalignment correction pattern formed on the endless belt. The recording medium skew obtaining unit obtains skew of the recording medium, transportable in a given direction, based on detection of an edge of the recording medium. The skew correction unit corrects an image forming position of the toner image to be formed on the image carrying member using correction data prepared from the obtained skew for the color image misalignment correction pattern and the obtained skew for the recording medium.

In another aspect of the present invention, a method of correcting deviation of color images formed in an image forming apparatus is devised. The image forming apparatus includes an endless belt, and a plurality of image forming units disposed along the endless belt. Each of the image forming units includes an image carrying member to form a toner image of each color thereon based on image data. The toner image of each color is sequentially transferable onto a recording medium as a superimposed color image. A color image misalignment correction pattern formed of toner image of each color is formed on the endless belt. The method includes steps of obtaining, obtaining, and correcting. In obtaining step, skew of toner image is obtained based on a detection result of the color image misalignment correction pattern formed on the endless belt. In obtaining step, skew of the recording medium, transportable in a given direction, is obtained based on detection of an edge of the recording medium. In correcting step, an image forming position of the toner image to be formed on the image carrying member is corrected using correction data prepared from the obtained skew for the color image misalignment correction pattern and the obtained skew for the recording medium.

In another aspect of the present invention, an image forming apparatus is devised that includes an endless belt, a plurality of image forming units, an image skew obtaining unit, a recording medium skew obtaining unit, and a skew correction unit. The plurality of image forming units is disposed along the endless belt. Each of the image forming units includes an image carrying member to form a toner image of each color thereon based on image data. The toner image of each color is sequentially transferable onto a recording medium as a superimposed color image. A color image misalignment correction pattern formed of toner image of each color is formed on the endless belt. The image skew obtaining unit obtains skew of toner image based on a detection result of the color image misalignment correction pattern formed on the endless belt. The color image misalignment correction pattern is detectable by a detector. The recording medium skew obtaining unit obtains skew of the recording medium, transportable in a given direction, based on detection of an edge of the recording medium. The edge of the recording medium is detectable by a detector. The skew correction unit corrects an image forming position of the toner image to be formed on the image carrying member using correction data prepared from the obtained skew for the color image misalignment correction pattern and the obtained skew for the recording medium.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a schematic configuration of an image forming apparatus according to an example embodiment;

FIG. 2 illustrates a schematic configuration of a sensor to detect a correction pattern formed on a transfer or media transport belt in the image forming apparatus of FIG. 1, and to detect a recording sheet transported in the image forming apparatus of FIG. 1;

FIG. 3 shows a block diagram of the image forming apparatus of FIG. 1;

FIG. 4 illustrates an example skewed condition of recording sheet, in which the sheet is slanted in a right side with respect to a transporting direction of sheet;

FIG. 5 illustrates an example skewed condition of recording sheet, in which the sheet is slanted in a left side with respect to a transporting direction of sheet;

FIG. 6 shows a timing chart explaining a timing of correcting writing timing in a sub-scanning direction by a writing controller.

FIG. 7 shows a block diagram of a writing controller shown in FIG. 3;

FIG. 8 illustrates an example correction pattern formed on a transfer or media transport belt and its skew;

FIG. 9 illustrates an example storing condition for line memory when a skew correction amount is within a correction range;

FIG. 10 illustrates an example storing condition for line memory when a skew correction amount exceeds a correction range;

FIG. 11 illustrates an example memory configuration, which is used by implementing gradation number reduction processing;

FIG. 12 illustrates an example configuration of line memory in view of correction range;

FIG. 13 illustrates an example skew correction processing when a skew correction amount is 1 dot;

FIG. 14 illustrates an example skew correction processing when a skew correction amount is 3 dots;

FIG. 15 shows an example process sequence chart for line memory for K color and M color;

FIG. 16 shows an example process sequence chart for line memory for C color and Y color; and

FIG. 17 shows a flowchart when sheets are consecutively printed while a skew correction is conducted.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing expanded views shown in the drawings, specific terminology is employed for the sake of clarity, the present disclosure is not limited to the specific terminology so selected and it is to be understood that each specific element includes all technical equivalents that operate in a similar manner.

Referring now to the drawings, an image forming apparatus according to an exemplary embodiment is described. The image forming apparatus may be copier employing an electrophotography system, for example, but not limited thereto.

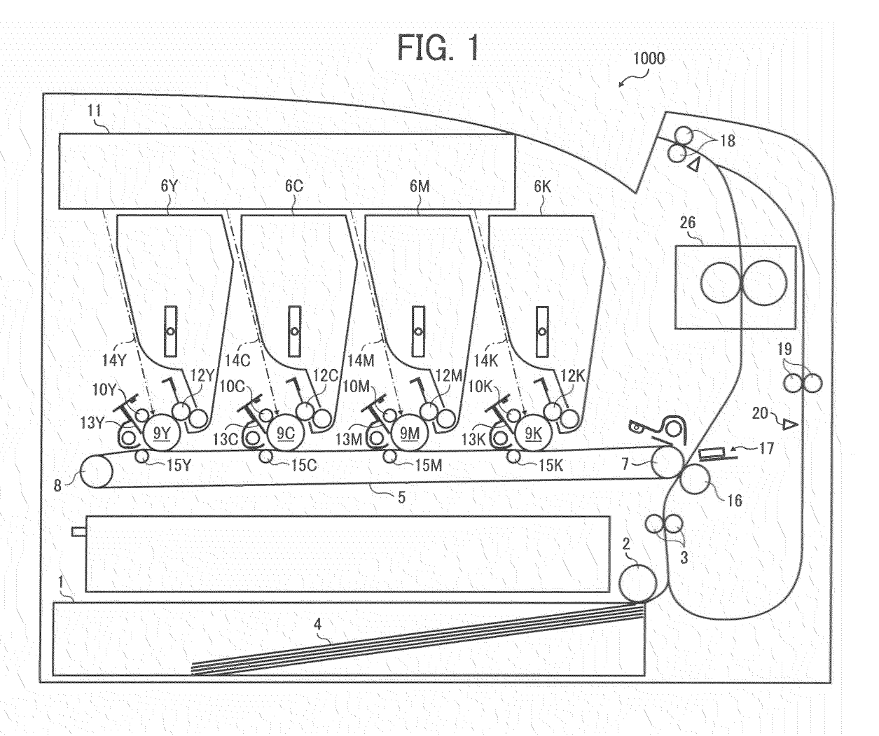

FIG. 1 illustrates a schematic configuration of an image forming apparatus 1000 according to an example embodiment. The image forming apparatus 1000 may be a tandem-type image forming apparatus such as printer. Although an image forming apparatus such as printer using an intermediate transfer technique for forming color image is described in this specification, the image forming apparatus is not limited thereto, but other types of image forming apparatus can be used. For example, a printer, a copier, a facsimile employing a direct transfer method, or a multifunctional peripheral having printer, copier, and facsimile functions can be used.

In the image forming apparatus 1000, process cartridges 6K, 6M, 6C, 6Y for each color may be arranged in a tandem manner along an intermediate transfer belt 5 used as an endless belt, for example. The process cartridge 6 may be referred to as all-in-one (AIO) cartridge, for example, which is used as image forming unit.

The intermediate transfer belt 5 may rotate in a counter-clockwise direction in FIG. 1. Each of the process cartridges 6K, 6M, 6C, 6Y may be disposed along the intermediate transfer belt 5 from an upstream side of rotary direction of intermediate transfer belt 5, for example. The process cartridge 6K is used to form a black image, the process cartridge 6M is used to form a magenta image, the process cartridge 6C is used to form a cyan image, and the process cartridge 6Y is used to form a yellow image.

The process cartridges 6K, 6M, 6C, 6Y may employ a similar configuration except color of development agent used for developing a latent image as a toner image. Accordingly, in the following description, the process cartridge 6K is described mainly because the process cartridges 6K, 6M, 6C, 6Y may employ a similar configuration.

The intermediate transfer belt 5 may be an endless belt extended by a secondary transfer drive roller 7 and a transfer belt tension roller 8. The secondary transfer drive roller 7 may be rotated by a drive motor, for example. Accordingly, the drive motor, the secondary transfer drive roller 7, and the transfer belt tension roller 8 may function as a drive unit to rotate the intermediate transfer belt 5 in a given direction.

The process cartridge 6K may include a photoconductor drum 9K used as an image carrying member.

The photoconductor drum 9K may be surrounded by a charger 10K, a development unit 12K, a cleaner blade 13K, or the like. The image carrying member is not limited to the photoconductor drums 9K, 9M, 9C, 9Y, but a photoconductor belt or the like can be employed.

The image forming apparatus 1000 may include an exposing unit 11. The exposing unit 11 irradiates laser beams 14K, 14M, 14C, 14Y to the process cartridges 6K, 6M, 6C, 6Y, respectively to form a latent image on the photoconductor drum 9, in which the laser beam 14 is used as an exposure light corresponding to a color of image to be formed. Specifically, the exposing unit 11 irradiates the laser beams 14K generated based on black image data onto the photoconductor drum 9K of the process cartridges 6K. Similarly, the exposing unit 11 irradiates the laser beam 14M generated based on magenta image data onto the photoconductor drum 9M of the process cartridges 6M, the laser beam 14C generated based on cyan image data onto the photoconductor drum 9C of the process cartridges 6C, and the laser beam 14Y generated based on yellow image data onto the photoconductor drum 9Y of the process cartridges 6Y.

When an image forming operation is conducted, the surface of the photoconductor drum 9K is uniformly charged by the charger 10K in a dark environment, and then the exposing unit 11 emits the laser beam 14K for black image data onto the photoconductor drum 9K to form a latent image for black image data on the photoconductor drum 9K. The development unit 12K develops the latent image using black toner. With such charging, exposing, and development processes, a black toner image is formed on the photoconductor drum 9K.

The black toner image is transferred from the photoconductor drum 9K to the intermediate transfer belt 5 at a primary transfer position K with an effect of a primary transfer roller 15K, wherein the primary transfer position K is set at a position that the photoconductor drum 9K and the intermediate transfer belt 5 contact each other. The photoconductor drum 9K, which has transferred the toner image, is cleaned by a cleaner blade 13K to remove toner remaining on the photoconductor drum 9K, by which the photoconductor drum 9K is ready for a next image forming operation.

Then, a portion of the intermediate transfer belt 5 transferred with the black toner image from the process cartridge 6K is transported to a position facing the process cartridge 6M by rotating the intermediate transfer belt 5 using the drive motor. In the process cartridge 6M, as similar to the image forming process for the process cartridge 6K, a magenta toner image is formed on the photoconductor drum 9M, and the magenta toner image is transferred superimposingly on the black image formed on the intermediate transfer belt 5 at a primary transfer position M, wherein the primary transfer position M is set at a position that the photoconductor drum 9M and the intermediate transfer belt 5 contact each other.

Then, the portion of the intermediate transfer belt 5 transferred and superimposed with the black toner image and magenta toner image is transported to a position facing the process cartridges 6C and 6Y. In the process cartridges 6C and 6Y, as similar to the image forming process for the process cartridge 6K, a cyan toner image is formed on the photoconductor drum 9C, and a yellow toner image is formed on the photoconductor drum 9Y. Then, the cyan toner image and yellow toner image are superimposingly transferred and superimposed on other toner images already transferred on the intermediate transfer belt 5.

With such processes, a full color image is formed on the intermediate transfer belt 5. As above described, the toner images of each of colors are formed on the respective photoconductor drum 9, and then transferred and superimposed on a same portion of the intermediate transfer belt 5 at the respective primary transfer position to form a full color image on the intermediate transfer belt 5. The intermediate transfer belt 5 having formed with the full color image is transported to a position (referred to as a secondary transfer position) facing the secondary transfer roller 16 and a secondary transfer roller.

When the above described image forming process is conducted, a recording sheet 4 stored in a sheet feed unit 1 as recording medium is fed by a sheet feed roller 2, rotatable in a counter-clockwise direction, to a registration roller 3, wherein the top sheet of recording sheet 4 stored in the sheet feed unit 1 is fed first. The registration roller 3 stops the recording sheet 4 for a while. Then, the registration roller 3 starts to rotate at a given time to synchronize a timing that the toner image transported by the intermediate transfer belt 5 and the recording sheet 4 come to the secondary transfer position at the same time. The registration roller 3 may rotate in a counter-clockwise direction to feed the recording sheet 4.

The registration roller 3 feeds the recording sheet 4 to the secondary transfer position, and then the toner image is transferred onto the recording sheet 4 from the intermediate transfer belt 5 using the secondary transfer roller 16. Then, the toner image is fixed on the recording sheet 4 in a fixing unit 26 by applying heat and pressure to the toner image. Then, an ejection roller 18 rotates in a counter-clockwise direction to eject the recording sheet 4 outside the image forming apparatus 1000.

If the toner images of each of colors are not superimposed each other, or if the toner images of each of colors are superimposed but deviated from intended positions of each of colors on the intermediate transfer belt 5, the toner images transferred on the intermediate transfer belt 5 at the secondary transfer position may have lower image quality, and thereby an image having lower image quality may be formed on the recording sheet 4.

In view of such misalignment of toner images of each of colors, a misalignment correction process toner image may be conducted, which is to be described hereinafter. In such misalignment correction process, toner images of each of colors are formed on the respective photoconductor drum 9 as “color image misalignment correction pattern (or correction pattern)” and then transferred on the intermediate transfer belt 5 separately so that a correction pattern used for correcting misalignment of toner image is formed on the intermediate transfer belt 5. As described later, the correction pattern formed on the intermediate transfer belt 5 is detected to obtain skew of tone images, which is skewed from a preferable or indented forming position of tone images. Based on such detection result of correction pattern, an image forming position of tone image on the photoconductor drum 9 may be changed or adjusted. As such, the detection result of correction pattern may be used as skew of tone images.

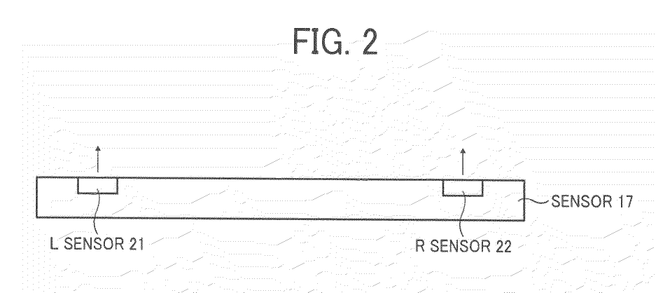

Further, the image forming apparatus 100 may include a sensor 17 disposed at a downstream side of the secondary transfer roller 16 in a transport route used for transporting the recording sheet 4. For example, the sensor 17 is disposed at a downstream and nearby the secondary transfer roller 16. FIG. 2 illustrates a schematic view of the sensor 17, which may be used as a detector to detect a “color image misalignment correction pattern” formed on the intermediate transfer belt 5, and to detect the recording sheet 4 transported in the transport route. The color image misalignment correction pattern may be simply referred to as correction pattern in the following description.

The sensor 17 may include a support plate, an L (left-side) sensor 21, and a R (right-side) sensor 22 disposed at each end of the support plate. The L sensor 21 and R sensor 22 may be a photo-electronic sensor used to detect a correction pattern.

In an example embodiment, one sensor (i.e., sensor 17) detects a “correction pattern” formed on the intermediate transfer belt 5, and also detects the recording sheet 4. However, instead of using one sensor as shown FIG. 2, two sensors can be used for detecting “correction patterns” formed on the intermediate transfer belt 5 and an orientation of the recording sheet 4. For example, one sensor may be disposed at a downstream side of the secondary transfer roller 16 in a transport route used for transporting the recording sheet 4 to detect an orientation of the recording sheet 4, and another sensor may be disposed between the process cartridge 6 and the secondary transfer position to detect correction patterns formed on the intermediate transfer belt 5.

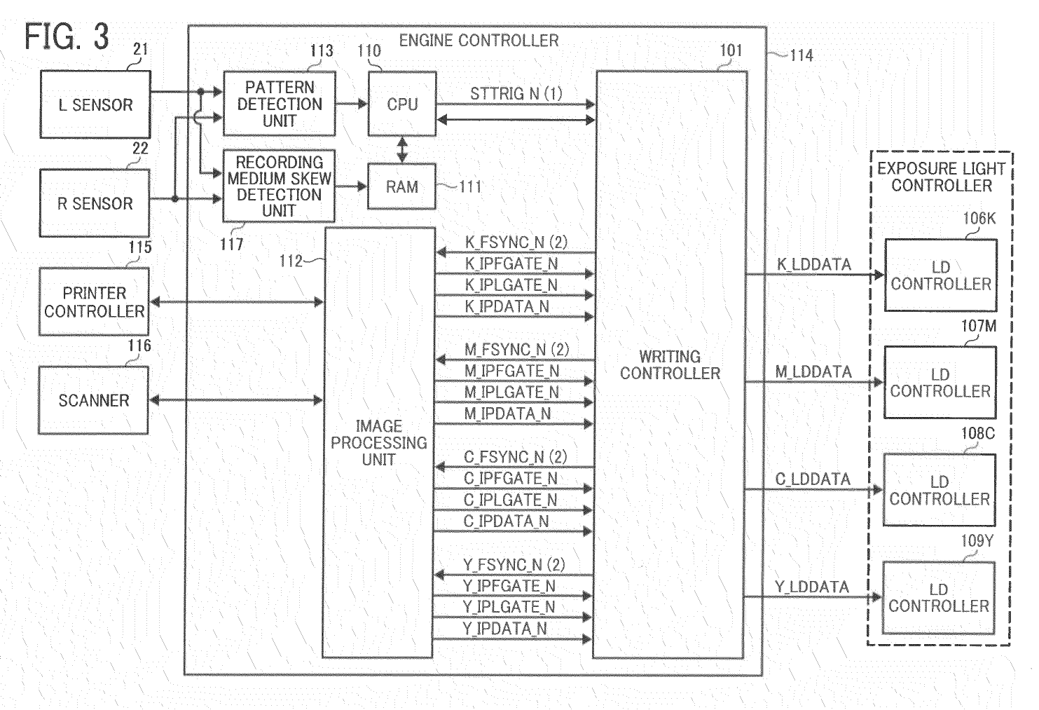

FIG. 3 illustrates an engine controller 114, which may control the exposing unit 11 and generate image data of each color. The exposing unit 11 irradiates the laser beams 14K, 14M, 14C, 14Y onto the photoconductors 9K, 9M, 9C, 9Y, and the laser beams 14K, 14M, 14C, 14Y are used to form a toner image on the photoconductors 9K, 9M, 9C, 9Y. Accordingly, the engine controller 114 may function as a controller for controlling image forming process.

The engine controller 114 may include a pattern detection unit 113, a recording medium skew detection unit 117, a central processing unit 110 (CPU 110), a random access memory 111 (RAM 111), an image processing unit 112, and a writing controller 101. The writing controller 101 may be connected to each of the LD controllers 106K, 107M, 108C, 109Y. The LD controllers may be a laser-diode controller, which may be referred to as an exposure light controller, in general.

The image processing unit 112 receives the sub-scanning timing signals (K, M, C, Y) FSYNC_N for each color from the writing controller 101. Then, the image processing unit 112 transmits main-scanning synchronizing signals (K, M, C, Y)_IPLGATE_N for each color, sub-scanning synchronizing signals (K, M, C, Y)_IPFGATE_N for each color, and image data (K, M, C, Y)_IPDATA_N associated to such synchronizing signals to the writing controller 101 as shown in FIG. 3.

Then, the writing controller 101 generates image data (K, M, C, Y)_LDDATA based on the main-scanning synchronizing signals (K, M, C, Y)_IPLGATE_N, the sub-scanning synchronizing signals (K, M, C, Y)_IPFGATE_N, image data (K, M, C, Y)_IPDATA_N associated to the synchronizing signals, and then the writing controller 101 transmits the image data (K, M, C, Y)_LDDATA to the LD controllers 106K, 107M, 108C, 109Y, respectively.

Further, the L sensor 21 and the R sensor 22 detect the color image misalignment correction pattern (or correction pattern) formed on the intermediate transfer belt 5, and then transmit a detection signal of the correction pattern to the pattern detection unit 113. The pattern detection unit 113 converts the detection signal into digital data, and stores the digital data in a memory such as RAM 111, for example.

Then, a CPU (central processing unit) 110 computes positional misalignment value for correction pattern using the digital data stored in the RAM 111, and stores the computed positional misalignment value in a memory such as RAM 111, for example.

Further, the L sensor 21 and the R sensor 22 may detect one edge (e.g., leading edge) of the recording sheet 4, and transmits detection signal to the recording medium skew detection unit 117. The recording medium skew detection unit 117 converts the detection signal to digital data, and stores the digital data of the recording sheet 4 in a memory such as RAM 111, for example. Then, the CPU 110 computes skew of the recording sheet 4 using the digital data stored in the RAM 111, and stores the skew of the recording sheet 4 as a detected result in a memory such as RAM 111, for example.

Further, based on the skew (or positional misalignment value) for correction pattern and the skew of the recording sheet 4 stored in the RAM 111, the CPU 110 computes the skew correction amount (hereinafter, may be referred to as skew correction data), and stores the skew correction data in the RAM 111.

As such, in an example embodiment, the CPU 110 may function as an image skew obtaining unit, a recording medium skew obtaining unit, and a correction data obtaining unit, and the RAM 111 may function as an image skew storage unit, a recording medium skew storage unit, and a skew correction data storage unit.

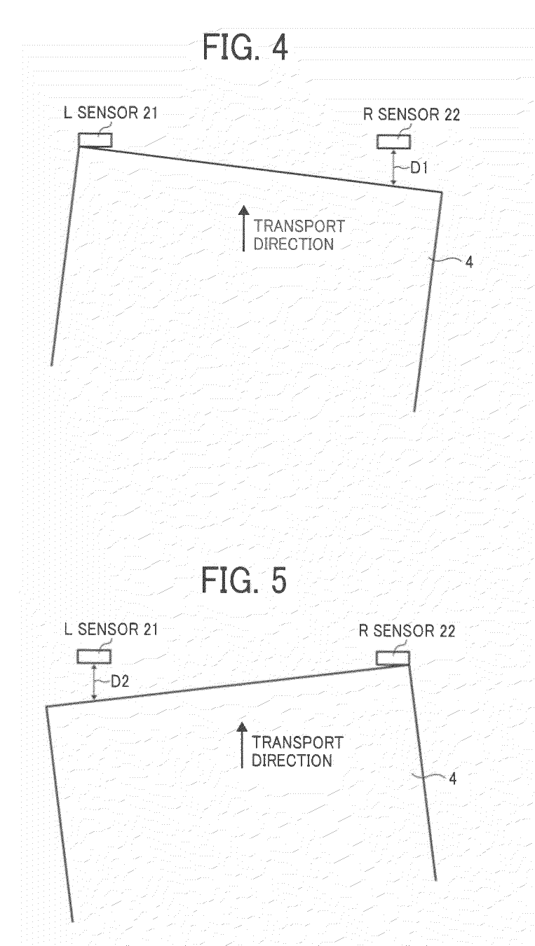

A description is now given to a skew detection process for the recording sheet 4 using the CPU 110 with reference to FIGS. 4 and 5. The skew of the recording sheet 4 indicates a slanting condition of the recording sheet 4 from a preferred or intended direction.

In FIG. 4, the recording sheet 4, slanted in a right side with respect to a transporting direction of sheet, passes the L sensor 21 and the R sensor 22 disposed in the sensor 17. In FIG. 4, the recording sheet 4 passes the L sensor 21 at first, and then the recording sheet 4 passes the R sensor 22 later. Accordingly, there is a time difference between a time when the recording sheet 4 passes the L sensor 21 and a time when the recording sheet 4 passes the R sensor 22. Based on the time difference and a transport speed of the recording sheet 4, a first distance D1 is computed and stored in a storage or memory (e.g., RAM 111).

In FIG. 5, the recording sheet 4, slanted in a left side with respect to the transporting direction of sheet, passes the L sensor 21 and the R sensor 22 disposed in the sensor 17. In FIG. 5, the recording sheet 4 passes the R sensor 22 at first, and then the recording sheet 4 passes the L sensor 21 later. Accordingly, there is a time difference between a time when the recording sheet 4 passes the R sensor 22 and a time when the recording sheet 4 passes the L sensor 21. Based on the time difference and a transport speed of the recording sheet 4, a second distance D2 is computed and stored in a storage or memory (e.g., RAM 111).

Such first distance D1 or the second distance D2 may be referred to as a skew of the recording sheet 4. As such, the skew of the recording sheet 4 may be detected using two sensors, in which one sensor detects the recording sheet 4 at first, and then other sensor detects the recording sheet 4 at a later timing, and a detection time difference between the two sensors and the transport speed of the recording sheet 4 are used to compute the skew of the recording sheet 4, for example.

The CPU 110 may use a timer to detect a time when one sensor detects a passing of recording sheet 4 and a time when other sensor detects a passing of recording sheet 4, wherein the one sensor inputs a detection signal to the CPU 110 and other sensor inputs other detection signal to the CPU 110 with some time delay. As such, a time interval between two detection signals can be obtained using the timer, for example.

Further, the image processing unit 112 may receive image data from the printer controller 115 or the scanner 116. Upon receiving such image data, the image processing unit 112 conducts image processing such as color conversion, gradation correction, halftone processing, or the like to the image data, but not limited thereto.

The writing controller 101 controls a writing process which uses a laser beam for image forming process, wherein the laser beam 14 may be directed onto the photoconductors 9K, 9M, 9C, 9Y to write a latent image thereon. Further, the CPU 110 controls operational control and computation in the image forming apparatus 1000 as a whole.

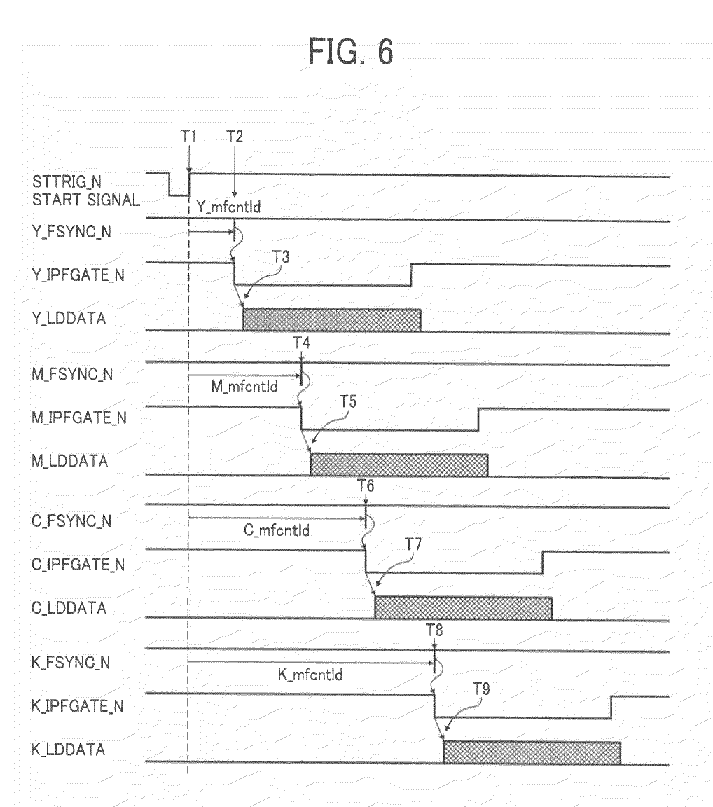

FIG. 6 shows a timing chart explaining a timing of correcting a writing timing in a sub-scanning direction, which may be conducted by the writing controller 101.

Using a start signal STTRIG_N transmitted from the CPU 110 as a trigger signal, the writing controller 101 outputs the sub-scanning timing signals K_FSYNC_N, M_FSYNC_N, C_FSYNC_N, Y_FSYNC_N to the image processing unit 112 at a time of T1.

The writing controller 101 receives the sub-scanning synchronizing signal Y_IPFGATE_N for Y color from the image processing unit 112 at a time of T2. The time T2 corresponds to a sub-scanning direction delayed timing Y_mfcntld, which is a given time delayed from a timing of receiving the sub-scanning timing signals K_FSYNC_N, M_FSYNC_N, C_FSYNC_N, Y_FSYNC_N by the image processing unit 112.

Then, using the reception of the sub-scanning synchronizing signal Y_IPFGATE_N for Y color as a trigger signal, the writing controller 101 transmits image data Y_LDDATA to the LD controller 109Y at a time of T3.

Similarly, as for M, C, K color, the writing controller 101 receives the sub-scanning synchronizing signal (M, C, K)_IPFGATE_N for each color from the image processing unit 112 at a time of T4, T6, T8, respectively. The time of T4, T6, T8 correspond to sub-scanning direction delayed timing (M, C, K)_mfcntld respectively, which is a give time delayed from a timing of receiving the sub-scanning timing signals M_FSYNC_N, C_FSYNC_N, K_FSYNC_N by the image processing unit 112. Then, the writing controller 101 transmits image data (M, C, K)_LDDATA to the LD controllers 107M, 1080, 106K at a time of T5, T7, T9, respectively.

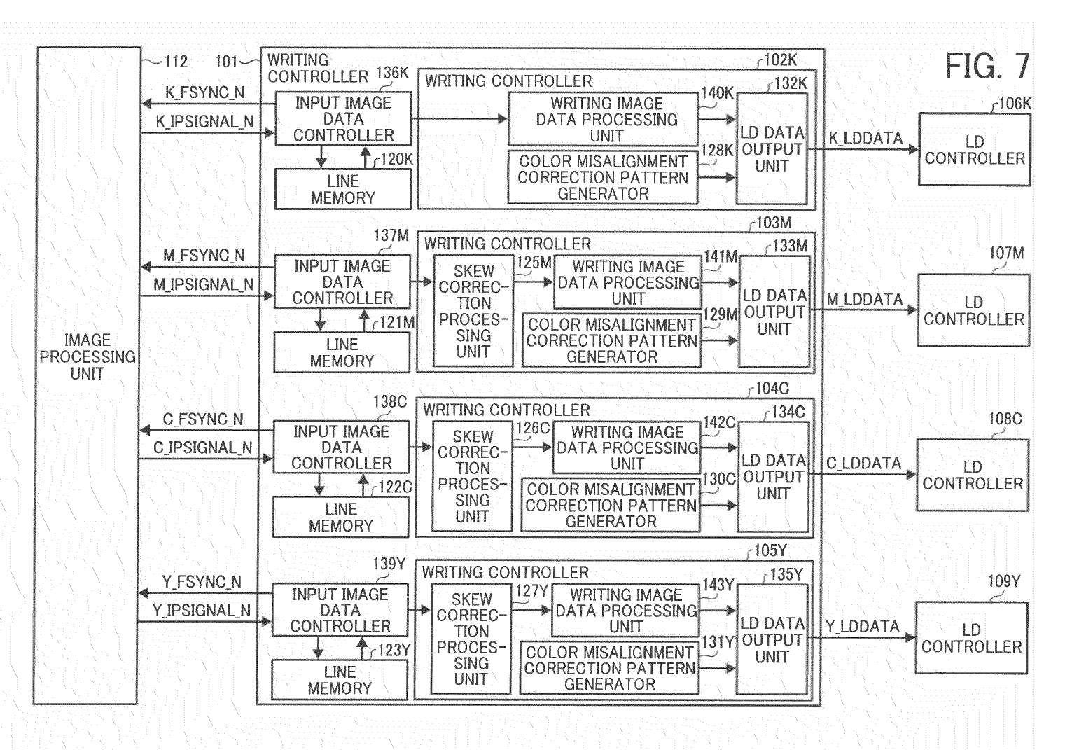

A description is now given to a configuration of the writing controller 101 with reference to FIG. 7, which shows an example block diagram of the writing controller 101 in detail. As shown in FIG. 7, the writing controller 101 may include input image data controllers 136K, 137M, 138C, 139Y, line memories 120K, 121C, 1220, 123Y, and writing controllers 102K, 103M, 104C, 105Y for K, M, C, Y. The line memories 120K, 121C, 122C, 123Y may be used as image data storage unit, and the writing controllers 102K, 103M, 104C, 105Y may be used as skew correction unit.

Further, the writing controller 102K may include a writing image data processing unit 140K, a color image misalignment correction pattern generator 128K, and a LD (laser diode) data output unit 132K, for example.

Further, the writing controller 103M may include a writing image data processing unit 141M, a color image misalignment correction pattern generator 129M, a LD data output unit 133M, and a skew correction processing unit 125M.

Further, the writing controller 104C may include a writing image data processing unit 142C, a color image misalignment correction pattern generator 130C, a LD data output unit 134C, and a skew correction processing unit 126C.

Further, the writing controller 105Y may include a writing image data processing unit 143Y, a color image misalignment correction pattern generator 131Y, a LD data output unit 135Y, and a skew correction processing unit 127Y. The color image misalignment correction pattern generator may be referred to as “color misalignment correction pattern generator” in FIG. 7.

In FIG. 3, three signals of the main-scanning synchronizing signal (K, M, C, Y)_IPLGATE_N, the sub-scanning synchronizing signal (K, M, C, Y)_IPFGATE_N, and the image data (K, M, C, Y)_IPDATA_N are shown. In FIG. 7, such three signals are collectively referred to as writing control signal (K, M, C, Y)_IPSIGNAL_N to simplify the expression.

In FIG. 7, when the image processing unit 112 receives the sub-scanning timing signal K_FSYNC_N from the writing controller 101, the image processing unit 112 transmits the writing control signal K_IPSIGNAL_N to the input image data controller 136K provided for the writing controller 102K. As such, a reception of the sub-scanning timing signal K_FSYNC_N is used as a trigger signal.

While the input image data controller 136K stores image data K IPDATA_N in the line memory 120K, the input image data controller 136K transmits the image data to the writing controller 102K. In the writing controller 102K, the writing image data processing unit 140K receives the image data from the input image data controller 136K, and then transmits the image data to the LD data output unit 132K. The LD data output unit 132K generates image data K_LDDATA for writing K color image, and transmits the image data K_LDDATA to the LD controller 106K.

Further, as for M, C, Y color, the input image data controllers 137M, 138C, 139Y store image data in the line memories 121M, 122C, 123Y based on the skew correction data (or skew correction amount) stored in the RAM 111. Based on the skew correction data, the skew correction processing units 125M, 126C, 127Y conduct skew correction processing to the image data stored in the line memories 121M, 121C, 123Y. Then, the skew correction processing units 125M, 126C, 127Y transmit the image data, which have received skew correction processing, to the writing image data processing units 141M, 142C, 143Y, respectively.

As similar to the process for K color, the writing image data processing units 141M, 142C, 143Y transmit the image data to the LD data output units 133M, 134C, 135Y, respectively. Then, the LD data output units 133M, 134C, 135Y generate and transmit image data (M, C, Y) LDDATA for writing M, C, Y color images to the LD controller 107M, 108C, 109Y, respectively. The skew correction processing will be described in detail later.

Further, when a correction pattern is to be output, the color image misalignment correction pattern generators 128K, 129M, 130C, 131Y transmit image pattern data for K, M, C, Y color to the LD data output units 132K, 133M, 134C, 135Y, respectively. Then, the LD data output units 132K, 133M, 134C, 135Y transmit writing image data corresponded to the correction pattern for K, M, C, Y color to the LD controller 106K, LD controller 107M, LD controller 108C, LD controller 109Y, respectively.

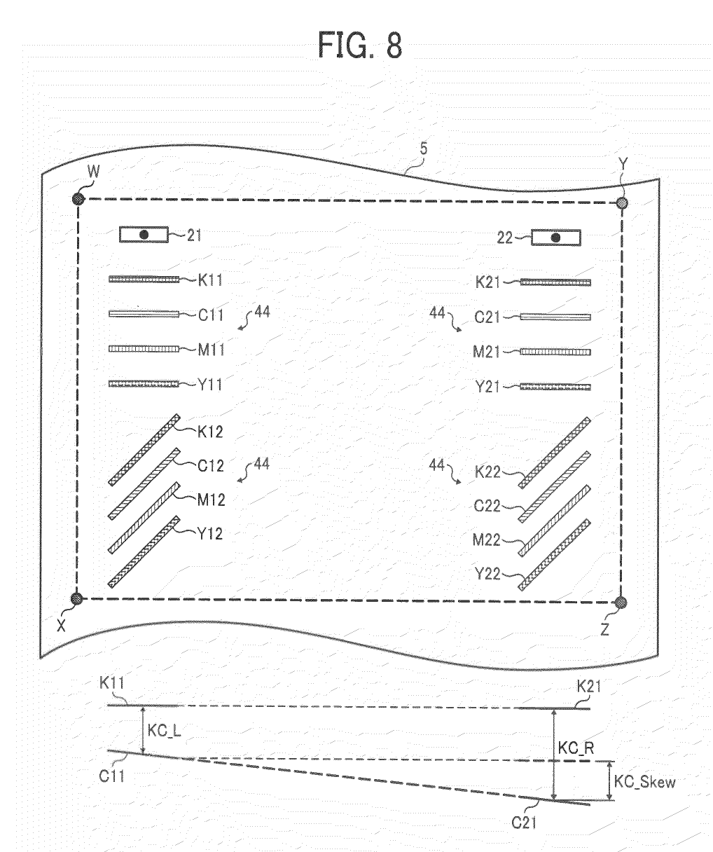

Hereinafter, a computing method of skew of toner image is described with reference to FIG. 8. FIG. 8 shows examples of correction pattern formed on the intermediate transfer belt 5 and skew computed from the correction pattern. As shown in FIG. 8, a correction pattern 44, including a plurality of color images, is formed on each lateral side (i.e., right and left side in FIG. 8) of the intermediate transfer belt 5, for example, wherein such lateral side is a position which can be sensed by the L sensor 21 and the R sensor 22. Accordingly, two groups (L-side pattern and R-side pattern) of correction pattern 44 are formed on the intermediate transfer belt 5. The correction pattern 44 is formed on the intermediate transfer belt 5 to detect positional misalignment of color images from a desired or intended position and is used as data for correcting the positional misalignment of color images. Specifically, patterns K11, C11, M11, Y11, K12, C12, M12, and Y12 may be formed at left side positions facing the L sensor 21, and patterns K21, C21, M21, Y21, K22, C22, M22, and Y22 may be formed at right side positions facing the R sensor 22, in which K, C, Y, M represents color of black, cyan, yellow, magenta, respectively.

For example, the L sensor 21 detects positions of the patterns K11 and C11 formed at the left side (L side), and computes a L-side distance KC_L, which is a distance between K color and C color at left side, based on a positional relation of patterns K11 and C11. The L sensor 21 may detect the patterns K11 and C11 by irradiating a light beam to the intermediate transfer belt 5 and receiving a reflection light from the patterns K11 and C11.

Similarly, the R sensor 22 detects positions of the patterns K21 and C21 formed at the right side (R side), and computes a R-side distance KC_R, which is a distance between K color and C color at right side, based on a positional relation of patterns K21 and C21. Then, a skew KC_Skew, which is a skew of C color with respect to K color (used as reference color) can be computed by the equation (1).

KC_Skew=KC_{—}R−KC_{—}L (1)

Further, skew KM_Skew and KY_Skew for M color and Y color with respect to K color (used as reference color) can be similarly computed based on a similar pattern detection process and following equations (2) and (3).

KM_Skew=KM_{—}R−KM_{—}L (2)

KY_Skew=KY_{—}R−KY_{—}L (3)

As such, using the equations (1) to (3), skew of C, M, Y color against K color (reference color) KC_Skew, KM_Skew, and KY_Skew can be computed.

Further, in an example embodiment, based on the above described skew KC_Skew, KM_Skew, KY_Skew and skew of recording sheet described with reference to FIGS. 4 and 5, a skew that needs to be corrected can be computed as skew correction data.

Accordingly, when the skew of recording sheet is set as P_Skew, and the skew of correction pattern 44 is set as Q_Skew (KC_Skew, KM_Skew, KY_Skew), the skew S_Skew, which needs to be corrected, can be computed by the following equation (4).

S_{—}Skew=P_Skew−Q_Skew (4)

The recording sheet skew P_Skew may be computed as below, for example. The recording sheet skew P_Skew may be computed when an image is to be formed (e.g., printed) on a recording medium such as recording sheet. For example, the skewed condition of recording sheet may be checked by computing the skew for one sheet, which was transported most recently, and the skew computed for the most recently transported sheet may be used for a subsequent sheet; or the skewed condition of sheet may be checked by computing the skew for two or more sheets, which were transported most recently, and the skew computed for the most recently transported two-or-more sheets may be averaged to compute an average skew of sheets, by which an average value of skew can be used to correct the skewed condition of sheets. If the average skew is used, the skew can be detected with higher precision.

In FIGS. 4 and 5, the skew can be computed by comparing a sheet-pass timing at left and right sides of the leading edge of the recording sheet 4. Further, the skew can be also computed by comparing a sheet-pass timing at left and right sides of rear edge of the recording sheet 4. Further, the skew can be computed using both of a sheet-pass timing of leading edge and a sheet-pass timing of rear edge of the recording sheet 4. With such method, the skew can be computed with higher precision.

Based on such computed skew, the skew correction processing may be conducted as follows using skew correction data prepared from the computed skew of correction pattern (e.g., toner image) and the computed skew of the recording sheet 4. Specifically, after storing image data in the line memories 120K, 121M, 122C, 123Y, the image data is processed by the skew correction processing using skew correction data, prepared from the computed skew of correction pattern and the computed skew of the recording sheet 4, and then the image data, having processed by the skew correction processing, is transmitted from the LD controller 106K, LD controller 107M, LD controller 108C, LD controller 109Y to the exposing unit 11. The exposing unit 11 emits light beams generated from such image data, which have received the skew correction processing, onto the photoconductors 9K, 9M, 9C, 9Y to write an latent image having received the skew correction processing.

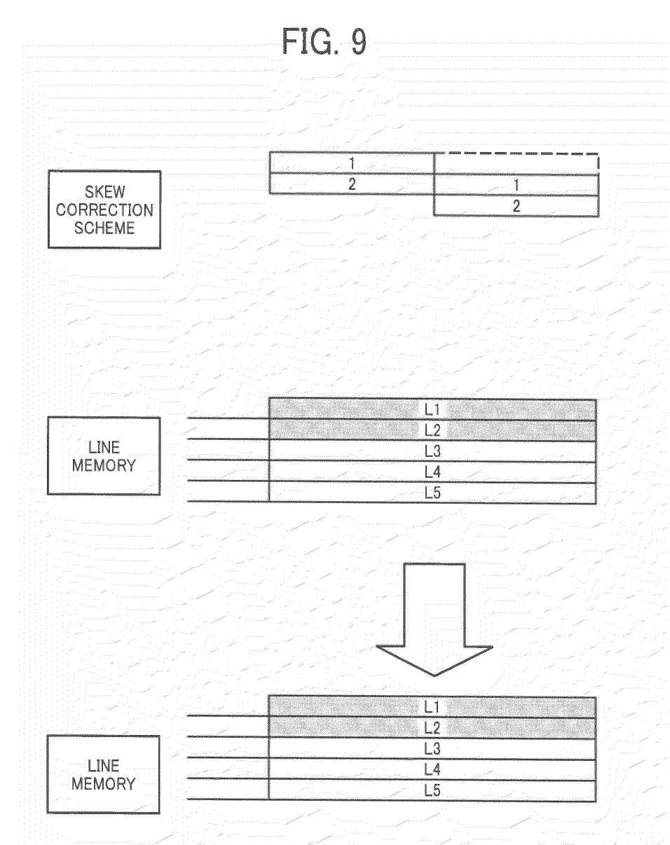

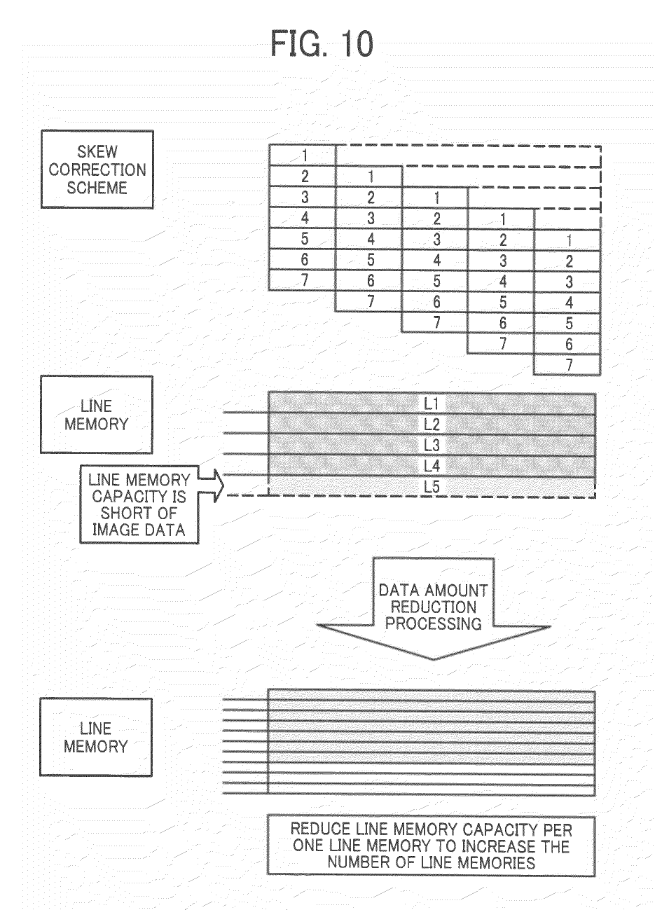

Hereinafter, a data storing process of image data to a line memory before image data receives the skew correction processing is described with reference to FIGS. 9 and 10. FIG. 9 shows an example storing condition of line memory when the skew correction amount is within a correction range, and FIG. 10 shows an example storing condition of line memory when the skew correction amount exceeds a correction range. The correction range is a limit that the skew correction can be conducted, wherein the correction range may be determined based on a line memory capacity.

In an example embodiment, skewed condition may be corrected by shifting pixels. Specifically, when the skewed condition is corrected by shifting pixels, at least one dot (1 dot) needs to be superimposed in a main scanning direction. Accordingly, when the correction range is set as “m,” the correction range “m,” which is numerical value, is determined by the following equation (5).

m=n−1 (dot) (5)

wherein “n” is line numbers of line memory.

Based on the line number of line memory, dot number, which can be used for skew correction can be computed by the equation (5). For example, if the line number of line memory is four lines, three lines can be used as the correction range, and if output resolution is set to 600 dpi (dot per inch), the three-line correction range for output resolution of 600 dpi can be converted to the distance of 127 μm, which is obtained by a computation of (25.4×1000/600)×3.

In case of FIG. 9, the line number of line memory required for skew correction processing is two lines (2 lines) when a skew correction processing is conducted by shifting pixels for one dot (1 dot), in which skew correction processing can be conducted within a correction range (four lines in FIG. 9). Accordingly, the image data can be stored in the line memory without shortage of line memory capacity.

On one hand, in case of FIG. 10, the line number of line memory required for skew correction processing is five lines (5 lines) when a skew correction processing is conducted by shifting pixels for four dots (4 dot), and the skew correction amount exceeds a correction range (e.g., four lines in FIG. 10). Accordingly, the line memory capacity becomes short compared to image data amount that needs to be processed. To secure required line numbers of line memory (five or more lines), data amount reduction processing may be conducted for the concerned image data, and then the concerned image data can be stored in the line memory.

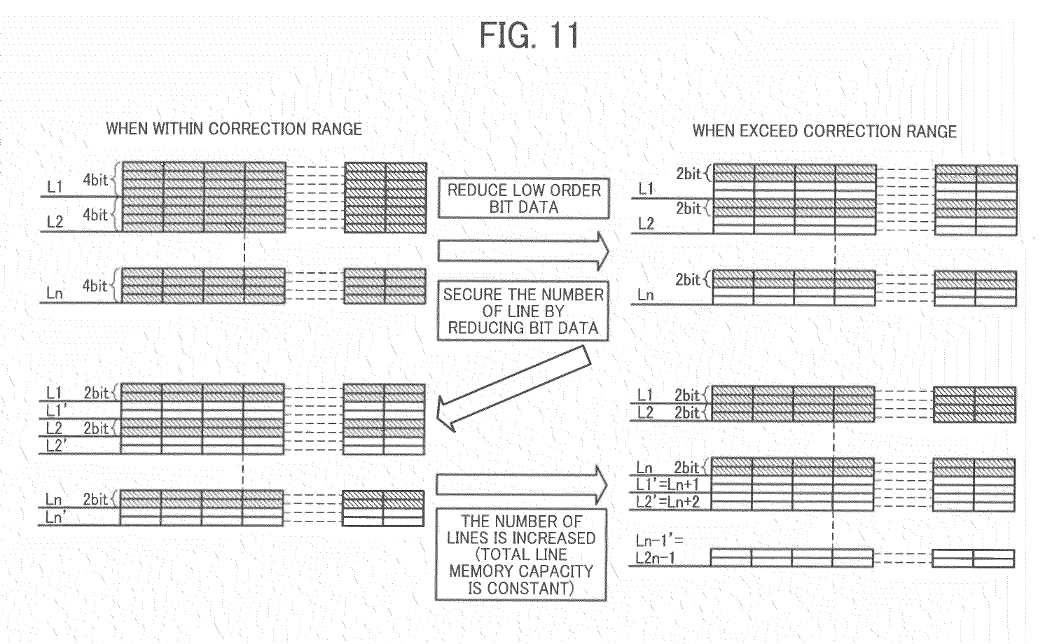

Hereinafter, data amount reduction processing for image data is described with reference to FIG. 11. FIG. 11 illustrates an example memory configuration, which is used by implementing gradation number reduction processing. By performing the gradation number reduction processing, a substantial correction range for image data can be expanded using an originally provided line memories, and the correction range for skew can be expanded without increasing the line memory capacity or the number of line memories.

For example, when the skew correction can be conducted within the correction range and the gradation number of image data is set to 4 bits, 4 bits of image data is stored in each of line memories L1, L2, . . . Ln as shown in FIG. 11.

When the skew correction cannot be conducted within a correction range, the gradation number of image data may be reduced from 4 bits to 2 bits, for example, and remaining 2 bits of image data is stored in each of the line memories L1, L2, . . . Ln. Accordingly, the line memory capacity per one line is reduced to half, by which a substantial line memory capacity used for correction range can be increased by two times. Therefore, the correction range for skew correction processing can be expanded by two times using originally provided line memories. When the skew correction can be conducted within an originally provided line memory capacity, such reduction of gradation number of image data is not required.

As such, when the skew correction amount exceeds a line memory capacity usable for correction range, the above-described gradation number reduction processing is conducted for image data of each color, and then the image data is stored in the line memories 120K, 121C, 122C, 123Y.

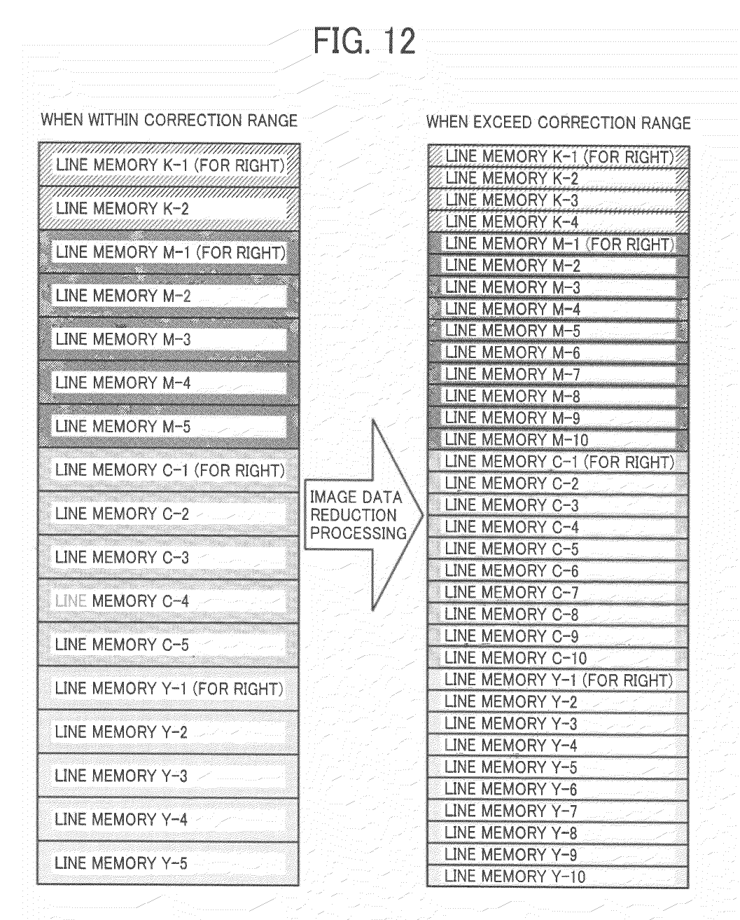

FIG. 12 illustrates an example configuration of line memories in view of correction range. When the skew correction can be conducted using originally-provided line memory capacity as a correction range, the line memory 120K includes two lines, the line memory 121M includes five lines, the line memory 122C includes five lines, and the line memory 123Y includes five lines as shown in “when the skew correction amount is within the correction range” in a left side in FIG. 12, for example.

However, when the skew correction cannot be conducted using originally-provided line memories as they are as a correction range for each color, in which skew correction exceeds a correction range of originally-provided line memories, the gradation number reduction processing is performed to increase line numbers of line memory of each color by two times as shown in “when the skew correction amount exceeds the correction range” in a right side in FIG. 12. Accordingly, line numbers of line memory of each color is changed by two times: the line memory 120K includes four lines; the line memory 121M includes ten lines; the line memory 122C includes ten lines; and the line memory 123Y includes ten lines.

Such gradation number reduction processing is performed to image data, and then the image data having received the gradation number reduction processing is stored in the line memory, and then skew correction is conducted.

Hereinafter, computation of the skew correction amount or skew correction data is described. TABLE 1 shows examples of computed skew. Symbol of +/− attached to numerical value indicates a shift direction of image data in a sub-scanning direction, and (+) direction and (−) direction can be set in any direction by maintaining (+/−) relationship. In an example embodiment, a leading edge of image is defined as plus (+) direction, which means the upper side of the drawing is defined as (+) direction.

TABLE 1

| Color | Skew |
|---|---|
| M skew (μm) | +110 |
| C skew (μm) | +130 |
| Y skew (μm) | −30 |

When an output resolution is set to 600 dpi, for example, in which one line of 600 dpi is used as minimum correction unit. Accordingly, by dividing the skew with the minimum correction unit (e.g., one line of 600 dpi), the skew correction amount shown in TABLE 2 can be obtained, for example.

TABLE 2

| Color | Skew correction amount |
|---|---|
| M skew correction amount | +2.6 |
| (dot) | |
| C skew correction amount | +3.1 |
| (dot) | |
| Y skew correction amount | −0.7 |
| (dot) | |

However, because the one line of 600 dpi is used as minimum correction unit, the number of digits after decimal point shown in TABLE 2 cannot be used for skew correction. In such case, value of the skew correction amount is set to an integral number by rounding, carrying-up, or carrying-down process for number. In this case, the value of the skew correction amount is rounded to obtain the skew correction amount shown in TABLE 3.

TABLE 3

| Color | Skew correction amount |
|---|---|
| M skew correction amount | +3 |
| (dot) | |
| C skew correction amount | +3 |
| (dot) | |
| Y skew correction amount | −1 |
| (dot) | |

The skew correction amount shown in TABLE 3 can be computed using the input image data controller 137M, 138C, 139Y (see block diagram of FIG. 7), and then stored in the RAM 111.

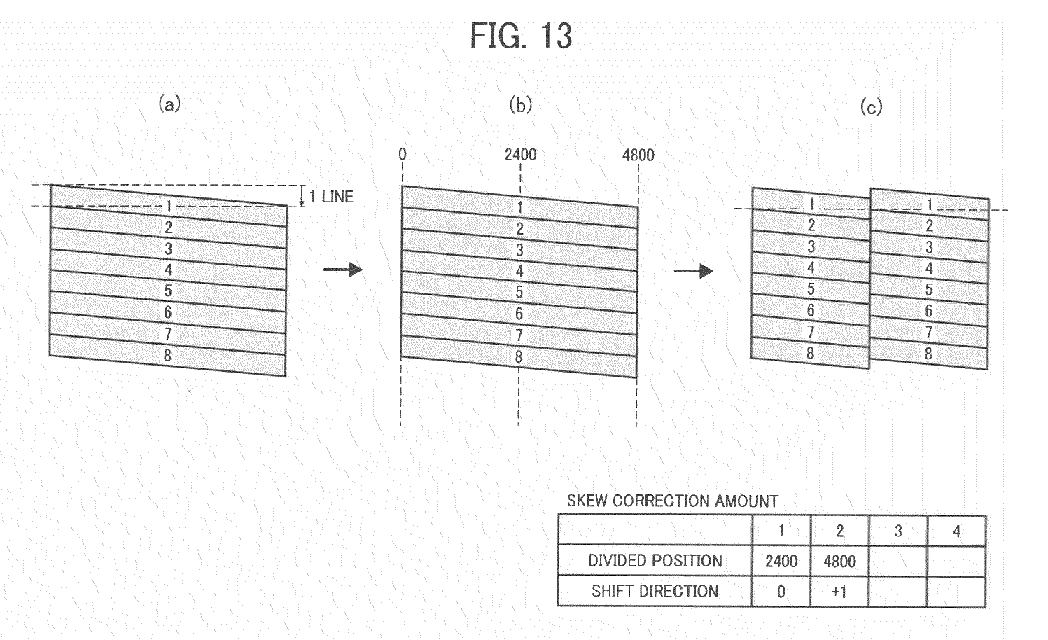

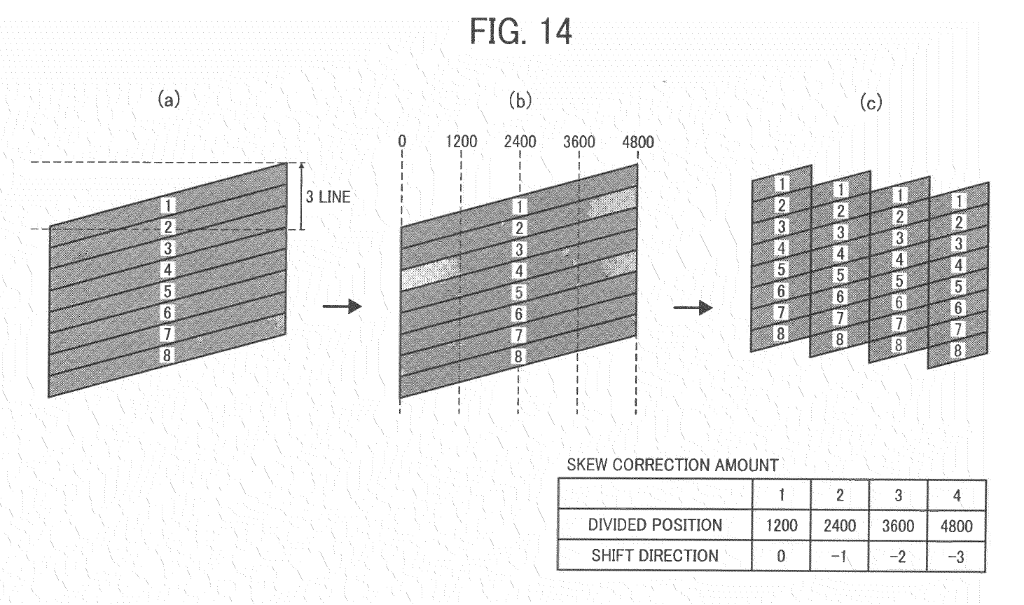

Hereinafter, an image correction processing using the above-described computed skew correction amount is described with reference to FIGS. 13 and 14.

FIG. 13 shows an example case that the skew correction processing is conducted when the skew correction amount is one dot (1 dot). FIG. 13(a) shows an example case that a given image is skewed for one line while skewing from left to right decreasingly with respect to (+) direction on the intermediate transfer belt 5.

FIG. 13(b) shows a state that image data having 4800 pixels in a main scanning direction is divided in two portions in a main scanning direction of the image data. The start point in the main scanning direction is set to the left edge of the image data, and the upper direction of sub-scanning direction of image is defined as plus (+) direction, wherein the image may be shifted in the sub-scanning direction for correcting skewed condition.

When the image data having 4800 pixels is divided in two portions at a dividing pixel position of 2400 pixels, the skew correction amount for the 2400 pixels and 4800 pixels becomes 0 and −1, respectively, and the image correction processing is conducted as shown in FIG. 13(c). FIG. 13(c) shows a state that the image correction processing is conducted by shifting the image data for one pixel in (+) direction in the sub-scanning direction.

FIG. 14 shows an example case that the skew correction processing is conducted when the skew correction amount is three dot (3 dots). FIG. 14(a) shows an example case that a given image is skewed for three lines while skewing from left to right increasingly with respect to (+) direction on the intermediate transfer belt 5.

FIG. 14(b) shows a state that image data having 4800 pixels in a main scanning direction is divided in four portions in a main scanning direction of the image data. When the image data having 4800 pixels is divided in four portions at dividing pixel positions 1200 pixels, 2400 pixels, 3600 pixels, the skew correction amount for the 1200 pixels, 2400 pixels, 3600 pixels and 4800 pixels becomes 0, −1, −2, and −3, respectively, and the image correction processing is conducted as shown in FIG. 14(c). FIG. 14(c) shows a state that the image correction processing is conducted by shifting the image data in (−) direction in the sub-scanning direction.

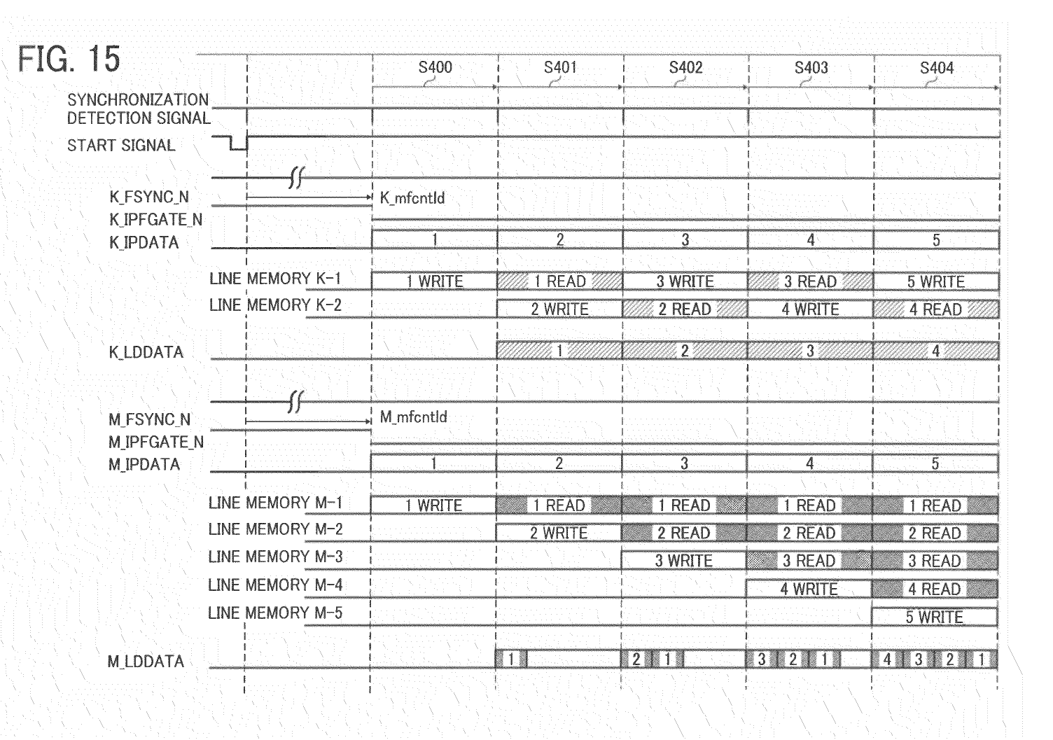

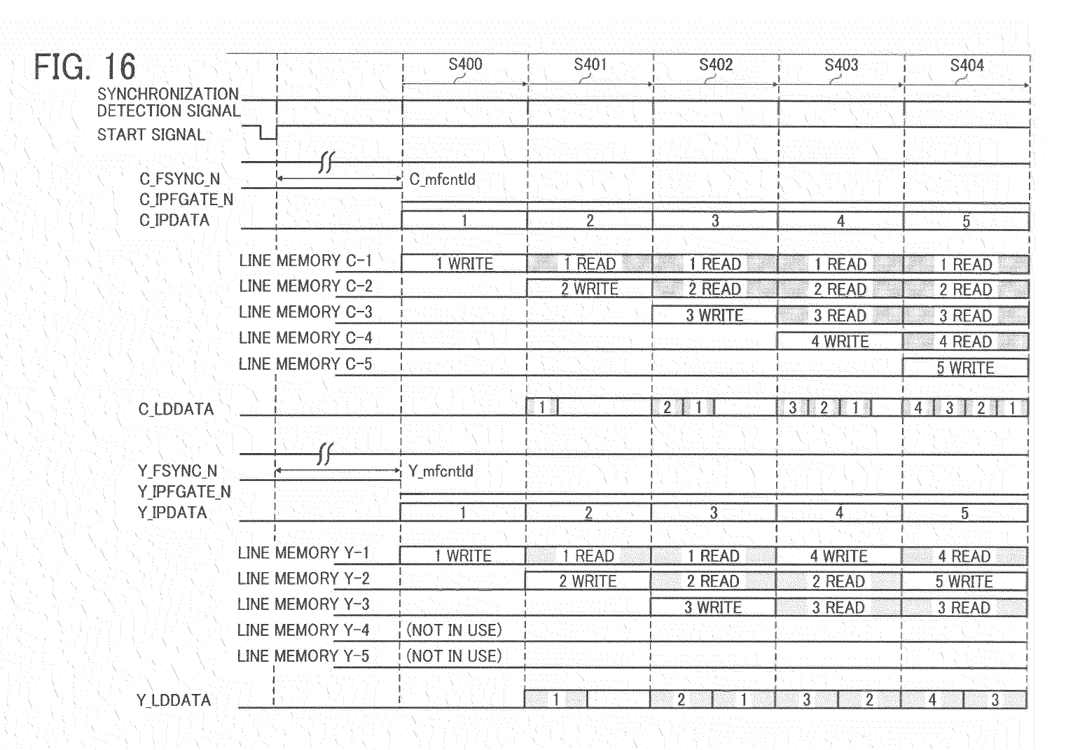

Hereinafter, a process sequence for line memory is described with reference to FIGS. 15 and 16, in which the skew correction amount shown in TABLE 3 is used. FIG. 15 shows an example process sequence chart for line memories for K color and M color, and FIG. 16 shows an example process sequence chart for line memories for C color and Y color. As previously described with FIGS. 13 and 14, because K color is used as reference color, the dividing process of line memory is not performed for K color. Because M and C color have the skew correction amount of 3 dots, a skew correction using four-dividing portion is performed. Because Y color has the skew correction amount of 1 dot, a skew correction using two-dividing portion is performed.

In FIG. 15, the input image data controller 136K starts a printing operation when the sub-scanning direction delayed timing K_Mfcntld and M_Mfcntld elapse after receiving the start signal of the CPU 110. When the printing operation starts, image data is stored in line memories K-1 and M-1 (step S400).

Then, at the same time that image data is stored in line memories K-2 and M-2, the image data is read from the line memories K-1 and M-1, and then the writing controller 102K outputs all pixels of image data K_LDDATA for writing K color, and the writing controller 103M outputs the first block of 4-divided image data M_LDDATA for writing M color (step S401).

Then, at the same time that image data is stored in the line memories K-1 and M-3, the image data is read from the line memories K-2, M-1, and M-2, and then all pixels of image data K_LDDATA for writing K color is output, and the second block of 4-divided image data M_LDDATA for writing M color is output (step S402).

Then, at the same time that image data is stored in the line memories K-2 and M-4, the image data is read from the line memories K-1, M-1, M-2, and M-3, and all pixels of image data K_LDDATA for writing K color is output, and the third block of 4-divided image data M_LDDATA for writing M color is output (step S403).

Then, at the same time that image data is stored in the line memories K-1 and M-5, the image data is read from the line memories K-2, M-1, M-2, M-3, and M-4, and all pixels of image data K_LDDATA for writing K color is output, and the fourth block of 4-divided image data M_LDDATA for writing M color is output (step S404).

The process sequence conducted for K color and M color is similarly conducted for C color and Y color as shown in FIG. 16 by performing a skew correction processing using four-dividing portion for C color and two-dividing portion for Y color.

As such, in the image forming apparatus 1000 according to an example embodiment, the skew of the recording sheet 4 can be computed without increasing the number of sensors. Further, the skew of the recording sheet 4 can be used with the skew computed from the correction pattern to correct a skewed condition of image to a desired orientation, and an image can be written on the photoconductors 9K, 9M, 9C, 9Y using image data having received the skewed correction processing.

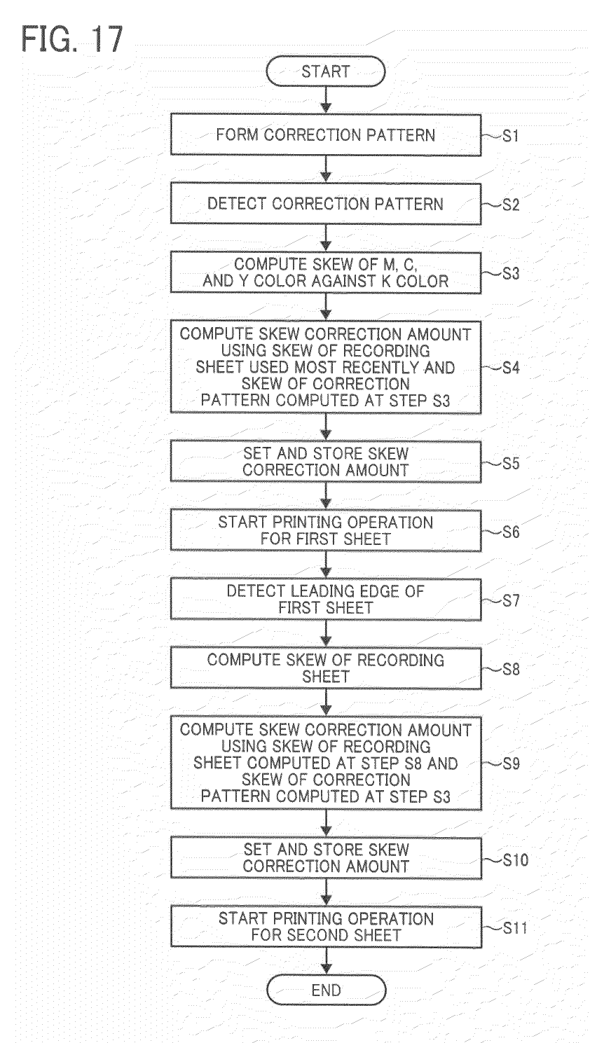

FIG. 17 shows a flowchart when image is formed (or printed) on a two sheets consecutively by conducting the above-described skew correction processing.

At first, the correction pattern 44 is formed on the intermediate transfer belt 5 (step S1). Then, the L sensor 21 and the R sensor 22 detect the correction pattern 44 (step S2). Then, skew of M, C, and Y color image against K color image is computed (step S3), in which K color image may be used as reference color. Then, using the skew of the recording sheet 4 obtained from a sheet used most recently and the skew computed at step S3, the skew correction amount (or skew correction data) is computed by the above-shown equation (5) at step S4, and then the skew correction amount is stored in the RAM 111 (step S5).

Then, using the computed skew correction amount (or skew correction data) stored in the RAM 111, image data to be used for an image printing operation is corrected, and the corrected image data is used to start the image printing operation on the first sheet (step S6). Then, the leading edge of the first sheet (e.g., recording sheet 4) is detected by the L sensor 21 and the R sensor 22 (step S7). Then, the skew of recording sheet is computed using the detection signal of the L sensor 21 and the R sensor 22 obtained at step S7 (step S8). Then, using the skew of recording sheet computed at step S8 and the skew of the correction pattern 44 computed at step S3, the skew correction amount is computed by the above-shown equation (5) at step S9, and the skew correction amount is stored in the RAM 111 (step S10). Then, using the skew correction amount stored in the RAM 111 at step S10, image data to be used for printing image is corrected, and the corrected image data is used to start a printing operation on the second sheet (step S11).

When type or size of the recording sheet 4 is changed for the image forming apparatus 1000, the recording sheet skew P_Skew stored in the RAM 111 may be initialized. With such process, a change of skew of recording sheet 4 when type or size of the recording sheet 4 is changed can be detected and updated. The initialization may be conducted at least by the CPU 100.

Further, the image forming apparatus 1000 (see FIG. 1) may include a cover to be opened (refer to be as openable cover) when given condition occurs. For example, the openable cover is opened when to replace consumable supplies such as toner, to replace photoconductor drum, or when to remove jammed sheets from the image forming apparatus 1000, but not limited these. When the openable cover is opened, the recording sheet skew P_Skew stored in the RAM 111 may be initialized. With such process, a change of skew of recording sheet when the openable cover is opened and closed can be detected and skew of recording sheet can be updated. The openable cover may be provided on a right side or upper side of the image forming apparatus 1000, for example.

The image forming apparatus 1000 employs an intermediate transfer system to transfer a four color toner images on the intermediate transfer belt 5 from the photoconductor drum 9 and then transfer the toner images on the recording sheet 4. However, the image forming apparatus 1000 can employ a direct transfer system to transfer four color toner images to the recording sheet 4 from the photoconductor drums 9 directly, in which a media transport belt for transporting the recording sheet 4 may be used as an endless belt, and a sensor for detecting the recording sheet 4 may be disposed at an upstream direction of one process cartridge 6, disposed at the most upstream among the plurality of process cartridges 6, at which a toner image is formed at the earliest timing among the plurality of process cartridges 6.

As above described, in an example embodiment, image forming units for each color disposed in an image forming apparatus form a correction pattern (of toner image) on an endless belt, for example. Then, the correction pattern is detected to compute skew of the correction pattern. Further, a recording medium being transported is detected to compute skew of recording medium. Then, based on the skew of toner image and skew of recording medium, the skew correction data for the image forming apparatus is obtained. Based on the skew correction data, the skew correction processing is conducted for the image forming apparatus. With such a configuration, even if a recording medium being transported is slanted in a given orientation, an image such as superimposed color image can be formed on the recording medium without slanting of image.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An image forming apparatus, comprising:
an endless belt;
a plurality of image forming units disposed along the endless belt, each of the image forming units including an image carrying member to form toner image of each color thereon based on image data provided to the image forming apparatus, the toner images of each color sequentially transferable onto a recording medium as a superimposed color image, a color image misalignment correction pattern formed of toner images of each color formable on the endless belt;
an image skew obtaining unit to obtain skew of toner image based on a detection result of the color image misalignment correction pattern formed on the endless belt;
a recording medium skew obtaining unit to obtain skew of the recording medium, the recording medium being transportable in a given direction, the recording medium skew obtained based on detection of an edge of the recording medium; and
a skew correction unit to correct an image forming position of a toner image to be formed on the image carrying member using correction data prepared from the obtained skew for the color image misalignment correction pattern and the obtained skew for the recording medium.

2. The image forming apparatus according to claim 1, further comprising a common detector that detects both the color image misalignment correction pattern and the edge of the recording medium to transmit both of the detection result for the color image misalignment correction pattern and the detection result for the edge of the recording medium as detection signals.

3. The image forming apparatus according to claim 1, wherein the recording medium skew obtaining unit obtains the skew of recording medium using a detection result of the edge of the recording medium transported most recently.

4. The image forming apparatus according to claim 1, further comprising:
an openable cover;
a recording medium skew storage unit to store the obtained skew of recording medium; and
an initializing unit to initialize value of the skew of recording medium stored in the recording medium skew storage unit when size or type of the recording medium is changed, or when the openable cover of image forming apparatus is opened.

5. The image forming apparatus according to claim 1, further comprising:
an image data storage unit to store the image data, the image data being dividable into a plurality of portions in a main scanning direction of the image data,
wherein the skew correction unit controls a read-out timing of each portion of the image data from the image data storage unit to shift an image forming position of a toner image to be formed on the image carrying member based on the correction data in a direction opposite to the obtained skew for the color image misalignment correction pattern and the obtained skew for the recording medium.

6. A method of correcting deviation of color images formed in an image forming apparatus,
the image forming apparatus including:
an endless belt; and
a plurality of image forming units disposed along the endless belt, each of the image forming units including an image carrying member to form a toner image of each color thereon based on image data, the toner image of each color sequentially transferable onto a recording medium as a superimposed color image, a color image misalignment correction pattern formed of toner image of each color formed on the endless belt,
the method comprising:
obtaining skew of toner image based on a detection result of the color image misalignment correction pattern formed on the endless belt;
obtaining skew of the recording medium, transportable in a given direction, based on detection of an edge of the recording medium; and
correcting an image forming position of the toner image to be formed on the image carrying member using correction data prepared from the obtained skew for the color image misalignment correction pattern and the obtained skew for the recording medium.

7. The method according to claim 6, wherein the obtaining step for obtaining skew of the recording medium uses a detection result of the edge of the recording medium transported most recently.

8. The method according to claim 6, the method further comprising:
storing the obtained skew of recording medium in a recording medium skew storage unit; and
initializing a value of the skew of recording medium stored in the recording medium skew storage unit when size or type of the recording medium is changed, or when the image forming apparatus is opened.

9. The method according to claim 6, the method further comprising:
storing the image data in an image data storage unit, the image data being dividable into a plurality of portions in a main scanning direction of the image data; and
in the step of correcting skewed condition, controlling a read-out timing for each portion of the image data from the image data storage unit to shift an image forming position of a toner image to be formed on the image carrying member based on the correction data in a direction opposite to the obtained skew for the color image misalignment correction pattern and the obtained skew for the recording medium.

10. An image forming apparatus, comprising:
an endless belt;
a plurality of image forming units disposed along the endless belt, each of the image forming units including an image carrying member to form toner image of each color thereon based on image data provided to the image forming apparatus, the toner images of each color sequentially transferable onto a recording medium as a superimposed color image, a color image misalignment correction pattern formed of toner images of each color formable on the endless belt;
an image skew obtaining unit to obtain skew of toner image based on a detection result of the color image misalignment correction pattern formed on the endless belt, the color image misalignment correction pattern detectable by a detector;
a recording medium skew obtaining unit to obtain skew of the recording medium, the recording medium being transportable in a given direction, the recording medium skew obtained based on detection of an edge of the recording medium, the edge of the recording medium detectable by a detector; and
a skew correction unit to correct an image forming position of a toner image to be formed on the image carrying member using correction data prepared from the obtained skew for the color image misalignment correction pattern and the obtained skew for the recording medium.

11. The image forming apparatus according to claim 10, wherein the detector for the color image misalignment correction pattern and the detector for the recording medium is a common detector that detects both the color image misalignment correction pattern and the edge of the recording medium to transmit both of the detection result for the color image misalignment correction pattern and the detection result for the edge of the recording medium as detection signals.
